(19) United States
(12) Patent Application Publication
(10) Pub. No.: US 2026/0112932 A1
(43) Pub. Date: Apr. 23, 2026

(54) BALANCED WINDING PATTERN WITH SPLIT RECTANGULAR BAR WIRE AND METHOD

(71) Applicants: FCA US LLC, Auburn Hills, MI (US); McMaster University, Hamilton (CA)

(72) Inventors: Arfakhshand Ali Qazalbash, Auburn Hills, MI (US); Yawei Wang, Hamilton (CA); Subhra Paul, Auburn Hills, MI (US)

(21) Appl. No.: 18/918,902

(22) Filed: Oct. 17, 2024

(51) Int. Cl. H02K 3/12; H02K 1/16; H02K 3/28; H02K 15/02; H02K 15/06; H02K 15/085

(52) U.S. Cl. CPC H02K 3/12; H02K 1/165; H02K 3/28; H02K 15/026; H02K 15/066; H02K 15/085

(57) ABSTRACT

A bar wound stator for an electric machine includes a stator core having a plurality of stator slots and a conductor assembly disposed in each slot. The conductor assembly includes a plurality of bar conductors having one or more first rectangular conductors with a first rectangular cross-section, and one or more split second rectangular conductors each having at least two split conductor members. Each split conductor member has a second rectangular cross-section smaller than the first rectangular cross-section, and each split conductor member is initially a straight bar member when inserted into the stator slot. The one or more split second rectangular conductors are configured to reduce AC copper loss of the electric machine.

### FIELD

The present application generally relates to electrical machines and, more particularly, to a bar winding configuration for a stator or rotor of an electric machine.

### BACKGROUND

Electric machines typically include a stator or rotor with windings formed by thin, individual copper wires. One type of electric machine is an electric traction motor, which can be utilized in electrified vehicles for both propulsion and as generators for energy recapture during braking. In recent years, bar/rectangular windings have been widely adopted in electric traction motors for various benefits compared to traditional stranded (round) windings. While bar/rectangular windings generally increase efficiency, they also can suffer from decreased efficiency at very high speed/operating regions. This is due to circulating eddy currents inside the rectangular conductors due to time-varying magnetic fields, especially near the slot opening region. The large cross-sectional area of the bar/rectangular wire experiences a higher induced current, which can potentially make the phenomenon worse when compared to stranded wires.

One solution to this decreased efficiency problem is using split bar configurations in the stator slots, but this can potentially cause AC copper loss due to circulating eddy currents that are higher in bar/rectangular windings compared to conventional stranded windings. These split bar configurations are also typically difficult to manufacture, involving bending/shaping the bar windings and then inserting them through the stator and finally twisting ends together to form a twisted joint. Such twisted joints, however, are not desirable because they could potentially damage insulation and degrade the electric traction motor's performance over time. Accordingly, while such systems work well for their intended purpose, there exists an opportunity for improvement in the relevant art.

### SUMMARY

According to one example aspect of the invention, a bar wound stator for an electric machine is provided. In one exemplary implementation, the stator includes a stator core having a plurality of stator slots and a conductor assembly disposed in each slot. The conductor assembly includes a plurality of bar conductors having one or more first rectangular conductors with a first rectangular cross-section, and one or more split second rectangular conductors each having at least two split conductor members. Each split conductor member has a second rectangular cross-section smaller than the first rectangular cross-section, and each split conductor member is initially a straight bar member when inserted into the stator slot. The one or more split second rectangular conductors are configured to reduce AC copper loss of the electric machine.

In addition to the foregoing, the described stator may include one or more of the following features: wherein the one or more split second rectangular conductors comprises first and second split conductors that together include first, second, third, and fourth split conductor members arranged in a radially outward order; a parallel connection scheme between the first and second split conductors of adjacent first and second conductor assemblies, the parallel connection scheme configured to reduce AC copper loss and minimize circulating currents under peak torque conditions at a predetermined base speed; and wherein the parallel connection scheme includes the first conductor member of the first conductor assembly coupled to the fourth conductor member of the second conductor assembly, the second conductor member of the first conductor assembly coupled to the third conductor member of the second conductor assembly, the third conductor member of the first conductor assembly coupled to the second conductor member of the second conductor assembly, and the fourth conductor member of the first conductor assembly coupled to the first conductor member of the second conductor assembly.

In addition to the foregoing, the described stator may include one or more of the following features: wherein a bottom surface of an end of the fourth conductor member of the first conductor assembly is welded to a top surface of an end of the first conductor member of the second conductor assembly; wherein the welded ends of the fourth conductor member of the first conductor assembly and the first conductor member of the second conductor assembly are not twisted; wherein a bottom surface of one split conductor member of a first conductor assembly is coupled to a top surface of another split conductor member of a second conductor assembly; wherein the coupling is welding; and wherein ends of the one split conductor and the another split conductor are not twisted at the coupling.

According to another example aspect of the invention a bar wound stator for an electric machine is provided. In one implementation, the stator includes a stator core having an inner surface, a plurality of stator slots extending radially outward from the inner surface, and first and second conductor assemblies disposed in adjacent stator slots. Each of the first and second conductor assemblies includes a plurality of first rectangular conductors having a first rectangular cross-section, and two split conductors that together include first, second, third, and fourth split conductor members arranged in a radially outward order and each having a second rectangular cross-section that is smaller than the first rectangular cross-section. A parallel connection scheme between the two split conductors of the first and second conductor assemblies is configured to reduce AC copper loss and minimize circulating currents under peak torque conditions at a predetermined base speed.

In addition to the foregoing, the described stator may include one or more of the following features: wherein the parallel connection scheme includes the first conductor member of the first conductor assembly coupled to the fourth conductor member of the second conductor assembly, the second conductor member of the first conductor assembly coupled to the third conductor member of the second conductor assembly, the third conductor member of the first conductor assembly coupled to the second conductor member of the second conductor assembly, and the fourth conductor member of the first conductor assembly coupled to the first conductor member of the second conductor assembly; wherein first, second, third, and fourth split conductor members are initially straight bar members inserted into the stator slot and subsequently bent after the insertion for the coupling to another split conductor member; and wherein ends of the first, second, third, and fourth split conductor members are not twisted after the coupling to the another split conductor member.

According to another example aspect of the invention, a method of manufacturing a bar wound stator is provided. In one example implementation, the method includes providing a stator core with an inner surface and first and second stator slots extending radially outward from the inner surface, providing first and second rectangular conductors each having a first rectangular cross section, and providing first and second split conductors each having first and second split conductor members, wherein each first and second split conductor members is a straight bar having a second rectangular cross section smaller than the first rectangular cross section. The method further includes inserting the straight first split conductor into the first stator slot, inserting the straight split conductor into the second stator slot, bending an end of the first split conductor after said inserting the first split conductor, bending an end of the second split conductor after said inserting the second split conductor, and coupling the end of the first split conductor to the end of the second split conductor.

In addition to the foregoing, the described stator may include one or more of the following features: wherein the ends of the first and second split conductors are coupled without twisting the ends; and wherein a bottom surface of the end of the first split conductor is coupled to a top surface of the end of the second split conductor.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a cross-sectional view of a portion of an example electric motor for an electric vehicle, in accordance with the principles of the present application;

FIG. 2 is an enlarged view of adjacent stator slots of a stator of the electric motor shown in FIG. 1 and illustrating an example split bar connection scheme, in accordance with the principles of the present application;

FIG. 3 is a perspective view of an example connection of split bars shown in FIG. 2, according to the principles of the present application;

FIG. 4A is a schematic illustration of an example insertion step in manufacturing the stator shown in FIG. 1, according to the principles of the present application; and

FIG. 4B is a schematic illustration of an example connection step in manufacturing the stator shown in FIG. 4A, according to the principles of the present application.

### DESCRIPTION

Described herein are systems and methods for manufacturing electric machines, such as electric traction motors, with a novel winding technique and configuration to reduce AC copper loss in the stator windings by up to 50%, leading to improved e-motor efficiency. The techniques include the insertion of straight rectangular bars/wires or conductors into stator slots. Once inserted, ends of the conductors are then bent and welded on both sides of the stator. This is in contrast to more conventional bar winding manufacturing techniques where pre-shaped/bent bar/rectangular wires/conductors are inserted into stator slots, twisted, and then welded. Another advantage of the proposed technique is the flexibility to weld any two conductors and to be able to connect split conductors to reduce AC copper loss and circulating currents.

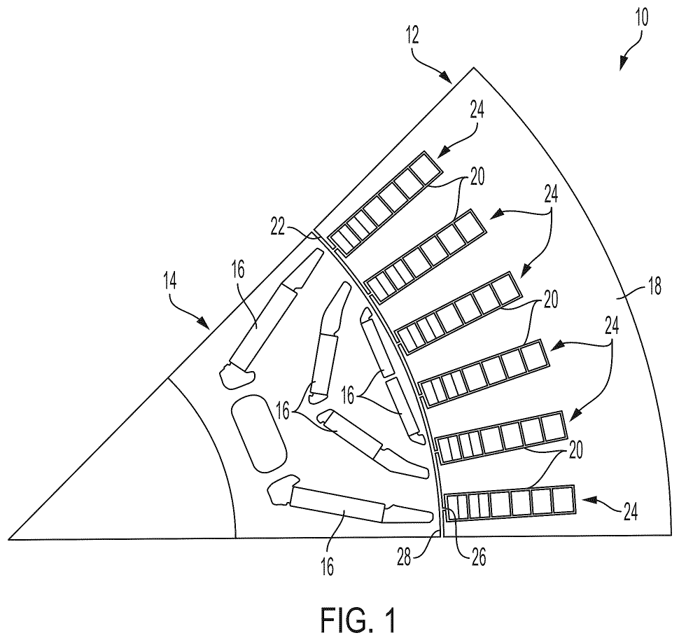

Referring now to FIG. 1, a portion of an example electric machine is illustrated and generally identified at reference numeral 10. In the example embodiments, the electric machine is described as an electric traction motor for an electric vehicle, but it will be appreciated that the features described herein may be applied to various electric machines. In the illustrated example, the electric traction motor 10 generally includes a stator 12 operably associated with a rotor 14 having a plurality of permanent magnets 16. The stator 12 includes a stator body or core 18 having a plurality of stator slots 20 extending generally radially outward from an inner surface 22.

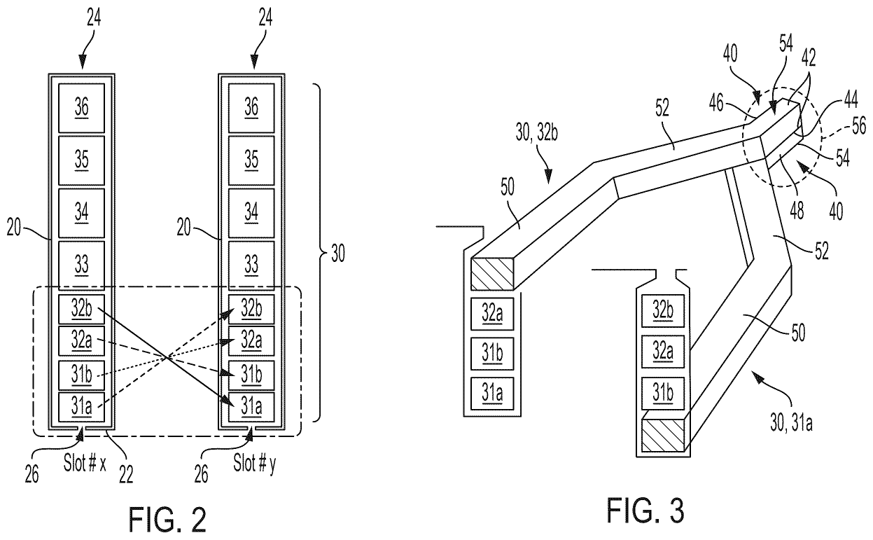

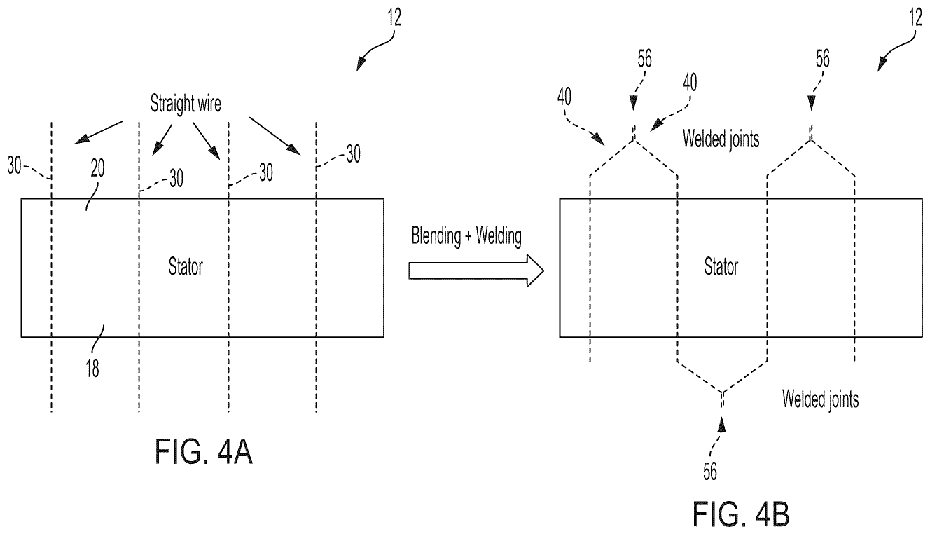

With additional reference to FIG. 2, a conductor assembly 24 is disposed in each stator slot 20. In the example embodiment, each conductor assembly 24 generally includes a plurality of bar/rectangular wires or conductors 30 configured to be inserted into the stator slots 20 to form the conductor assembly 24. As described herein in more detail, each conductor 30 is a straight bar inserted into the stator slot 20 as shown in FIG. 4A, and the ends of the rectangular conductors 30 are then bent and welded (FIG. 4B) according to the scheme shown in FIG. 2.

In the example embodiment, each stator slot 20 includes a first split conductor 31 and a second split conductor 32. The use of the split conductors (as opposed to the full size conductors) is configured to reduce the AC copper loss in the stator slots 18 by reducing the total cross-section of the bar/rectangular wires. To maximize performance, the split conductors 31, 32 are arranged further toward the stator inner surface 22 in the vicinity of a slot opening 26 (FIG. 1). In the example embodiment, the first split conductor 31 is disposed radially inward of the second split conductor 32. Such an arrangement disposes the split bars closer to the air gap 28 (FIG. 1) where such bars experience the most significant magnetic flux variation.

As shown in FIG. 2, in the example embodiment, the first split conductor 31 is formed from a first conductor member 31a and a second conductor member 31b. Similarly, the second split conductor 32 is formed from a first conductor member 32a and a second conductor member 32b. Arranged in radially outward progression from the second split conductor 32 is a bar conductor 33, a bar conductor 34, and a bar conductor 36. In some examples, regular conductors 33-36 have the same or substantially the same size first cross-section, and/or split conductor members 31a-b, 32a-b have the same or substantially the same size second size cross-section, which is smaller than the first cross-section. Although each stator slot 20 is illustrated with two split conductors and four full size conductors, it will be appreciated that stator slots 20 may have greater or fewer numbers of each of the split conductors and full size conductors depending on the machine or desired operation.

In the example implementation, utilizing the split conductors 31, 32 increases the number of conductors per slot, and parallel paths are introduced for the split-bars to balance the induced voltage of each phase winding. However, the resistances of these split-bars vary from each other due to the variable magnetic flux in the stator slot 20. Therefore, circulating current is inevitable between these parallel paths. To maximize performance, the rectangular conductors 31, 32 are advantageously arranged in the parallel connection scheme shown in FIG. 2 to thereby minimize circulating currents under peak torque conditions at a predetermined base speed.

With reference now to FIGS. 2 and 3, the connection scheme of split conductors 31, 32 is described in more detail. In the example embodiment, split conductor member 31a is connected to adjacent split conductor member 32b, split conductor member 31b is connected to adjacent split conductor member 32a, split conductor member 32a is connected to adjacent split conductor member 31b, and split conductor member 32b is connected to adjacent split conductor member 31a.

As shown in FIG. 3, each conductor 30 has an end 40 with an upper surface 42, a lower surface 44, and opposed side surfaces 46, 48. For each connected pair, the ends 40 are bent towards each other such that each end 40 has an inner straight portion 50, an inwardly angled portion 52, and an outer straight portion 54. The lower surface 44 of one outer straight portion 54 is subsequently coupled (e.g., welded) to the upper surface 42 of the other outer straight portion 54 to form a welded joint 56. As such, the adjacent conductors 30 (conductors 32b and 31a illustrated) are oriented in a stacked fashion with outer straight portions 54 aligned or substantially aligned in the same direction, which can be parallel or substantially parallel to the direction of inner straight portions 50. In this way, the conductors 30 are advantageously connected without twisting the end winding joints, which twisting may damage the insulation and degrade the machine performance over time.

In much the same way, the lower surface 44 of split conductor member 32a-x can be coupled to the upper surface 42 of split conductor member 31b-y, the upper surface 42 of split conductor member 31b-x can be coupled to the lower surface 44 of split conductor member 32a-y, and the upper surface 42 of split conductor member 31a-x can be coupled to the lower surface 44 of split conductor member 32b-y, as referenced in slots −x and −y in FIG. 2.

With reference now to FIGS. 4A and 4B, a method of manufacturing stator 12 will be described in more detail. In a first step, stator core 18 is provided with a plurality of slots 20 extending generally radially outward from the inner surface 22. In a second step, a plurality of rectangular bar conductors 30 are provided. More specifically, in the example embodiment, two split conductors 31, 32 and four regular conductors 33-36 are provided for each stator slot 20. Each conductor 30 is provided as a straight or substantially straight conductor without any pre-bending or pre-coupling. It will be appreciated that conductors 33-36 may be electrically coupled in various series or parallel configurations.

In a third step, the straight conductors 30 are inserted into the stator slot 20, as shown in FIG. 4A. In a fourth step, the ends 40 of adjacent conductors 30 are bent towards each other to be arranged, for example, as shown in FIG. 3. In a fifth step, the ends 40 are then welded to each other. In the example implementation, adjacent split conductors 31a-b, 32a-b are coupled according to the scheme shown in FIG. 2.

Described herein are systems and methods for conductor assemblies for stators of electric machines for electric vehicles. The conductor assemblies include split bar conductors arranged near the stator slot with larger rectangular conductors arranged radially outward thereof. Manufacturing is improved by first inserting straight conductors into the stator slots, and then subsequently performing bending and welding operations. A unique split bar connection scheme minimizes circulating currents. The design advantageously reduces the AC copper loss of bar/rectangular winding machines, thereby minimizing circulating currents and alleviating the manufacturing difficulties of twisting the end windings in conventional winding techniques. A significant reduction of copper loss occurs under both base speed and maximum speed operation points.

The example embodiments of the invention have been explained by way of example with reference to a stator of an electric machine. It will be appreciated, however, that the designs described here are also suitable for a rotor of an electric machine.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

What is claimed is:

1. A bar wound stator for an electric machine, comprising:
a stator core having a plurality of stator slots; and
a conductor assembly disposed in each slot and including a plurality of bar conductors that includes:
one or more first rectangular conductors having a first rectangular cross-section; and
one or more split second rectangular conductors each having at least two split conductor members, wherein each split conductor member has a second rectangular cross-section smaller than the first rectangular cross-section, and wherein each split conductor member is initially a straight bar member when inserted into the stator slot;
wherein the one or more split second rectangular conductors are configured to reduce AC copper loss of the electric machine.

2. The bar wound stator of claim 1, wherein the one or more split second rectangular conductors comprises first and second split conductors that together include first, second, third, and fourth split conductor members arranged in a radially outward order.

3. The bar wound stator of claim 2, further comprising a parallel connection scheme between the first and second split conductors of adjacent first and second conductor assemblies, the parallel connection scheme configured to reduce AC copper loss and minimize circulating currents under peak torque conditions at a predetermined base speed.

4. The bar wound stator of claim 3, wherein the parallel connection scheme comprises:
the first conductor member of the first conductor assembly coupled to the fourth conductor member of the second conductor assembly;
the second conductor member of the first conductor assembly coupled to the third conductor member of the second conductor assembly;
the third conductor member of the first conductor assembly coupled to the second conductor member of the second conductor assembly;
the fourth conductor member of the first conductor assembly coupled to the first conductor member of the second conductor assembly.

5. The bar wound stator of claim 4, wherein a bottom surface of an end of the fourth conductor member of the first conductor assembly is welded to a top surface of an end of the first conductor member of the second conductor assembly.

6. The bar wound stator of claim 5, wherein the welded ends of the fourth conductor member of the first conductor assembly and the first conductor member of the second conductor assembly are not twisted.

7. The bar wound stator of claim 1, wherein a bottom surface of one split conductor member of a first conductor assembly is coupled to a top surface of another split conductor member of a second conductor assembly.

8. The bar wound stator of claim 7, wherein the coupling is welding.

9. The bar wound stator of claim 7, wherein ends of the one split conductor and the another split conductor are not twisted at the coupling.

10. A bar wound stator for an electric machine, comprising:
a stator core having an inner surface;
a plurality of stator slots extending radially outward from the inner surface;
first and second conductor assemblies disposed in adjacent stator slots, each of the first and second conductor assemblies including:
a plurality of first rectangular conductors having a first rectangular cross-section; and
two split conductors that together include first, second, third, and fourth split conductor members arranged in a radially outward order and each having a second rectangular cross-section that is smaller than the first rectangular cross-section;
a parallel connection scheme between the two split conductors of the first and second conductor assemblies configured to reduce AC copper loss and minimize circulating currents under peak torque conditions at a predetermined base speed.

11. The bar wound stator of claim 10, wherein the parallel connection scheme comprises:
the first conductor member of the first conductor assembly coupled to the fourth conductor member of the second conductor assembly;
the second conductor member of the first conductor assembly coupled to the third conductor member of the second conductor assembly;
the third conductor member of the first conductor assembly coupled to the second conductor member of the second conductor assembly;
the fourth conductor member of the first conductor assembly coupled to the first conductor member of the second conductor assembly.

12. The bar wound stator of claim 11, wherein first, second, third, and fourth split conductor members are initially straight bar members inserted into the stator slot and subsequently bent after the insertion for the coupling to another split conductor member.

13. The bar wound stator of claim 12, wherein ends of the first, second, third, and fourth split conductor members are not twisted after the coupling to the another split conductor member.

14. A method of manufacturing a bar wound stator, comprising:
providing a stator core with an inner surface and first and second stator slots extending radially outward from the inner surface;
providing first and second rectangular conductors each having a first rectangular cross section;
providing first and second split conductors each having first and second split conductor members, wherein each first and second split conductor members is a straight bar having a second rectangular cross section smaller than the first rectangular cross section;
inserting the straight first split conductor into the first stator slot;
inserting the straight split conductor into the second stator slot;
bending an end of the first split conductor after said inserting the first split conductor;
bending an end of the second split conductor after said inserting the second split conductor; and
coupling the end of the first split conductor to the end of the second split conductor.

15. The method of claim 14, wherein the ends of the first and second split conductors are coupled without twisting the ends.

16. The method of claim 14, wherein a bottom surface of the end of the first split conductor is coupled to a top surface of the end of the second split conductor.
